(19) United States
(12) Patent Application Publication
(10) Pub. No.: US 2026/0175788 A1
(43) Pub. Date: Jun. 25, 2026

(54) UNDERWATER VEHICLES FOR NAVIGATING RELATIVE TO A STRUCTURE

(71) Applicant: HULLBOT PTY LTD, Rozelle (AU)

(72) Inventors: Thomas Loefler, Sydney (AU); Karl Aquaviva Watfern, Queensland (AU); Benjamin James Dwyer, Sydney (AU); Benedict Charles Dupree, Sydney (AU); Jack Ritchie Scott, Sydney (AU)

(21) Appl. No.: 19/129,175

(22) PCT Filed: Nov. 10, 2023
(86) PCT No.: PCT/AU2023/051139

§ 371 Date: May 12, 2025

(30) Foreign Application Priority Data
Nov. 11, 2022 (AU) 2022903398

(51) Int. Cl. B60R 11/04; H04N 23/90

(52) U.S. Cl. CPC B60R 11/04; H04N 23/90; B60R 2300/105

(57) ABSTRACT

Underwater vehicle (10) for navigating relative to a structure 11 submerged in a body of water. The vehicle (10) includes a body (12) defining a peripheral region (14), one or more drive mechanisms (16), and a plurality of imaging modules (18) carried by the body (12) to face away from the peripheral region (14). The plurality of imaging modules (18) are configured to operate concurrently to allow imaging at least partially about at least two of a front (20), opposed sides (22, 24), top (34) and bottom (35) of the body (12). The vehicle (10) also includes a controller (26) communicatively coupled with the imaging modules (18) and the drive mechanisms (16), and configured to control operation of the drive mechanisms (16) to navigate the vehicle (10) about the structure based on images captured by the imaging modules (18).

### TECHNICAL FIELD

The present disclosure relates, generally, to underwater vehicles configured to localise and navigate relative to a structure submerged in a body of water and, particularly, to such vehicles configured for interacting with the underwater structure, particularly to remove fouling from the hull of a vessel.

### BACKGROUND

Various remotely-operable or autonomous vehicles configured for underwater navigation are known. Typically, navigation of the vehicle is enabled by operating drive mechanisms, such as propellers or thrusters, and is guided by processing acoustic sensor signals, such as obtained from a sonar system. This approach to navigation is generally acceptable when navigating through open water, where there are few obstacles with which the vehicle may collide and therefore a wide tolerance for positional accuracy, speed of actuation, and responsiveness is acceptable. However, when operating such systems in close range to fixed or generally immovable structures, such as in a harbour containing boats, or when navigating relative to dynamic structures, such as a boat tethered to a mooring and being moved by currents, the positional accuracy provided by acoustic-based navigation systems can be insufficient to avoid collisions, and generally insufficient to allow the vehicle to interact with the structure.

Some underwater vehicles are equipped with an optical imaging system, typically intended for inspection of underwater structures and/or marine life. Past attempts to navigate based on images obtained from such optical systems alone, or in combination with acoustic signals, have achieved limited success. The low level of light available in underwater environments, potential for turbulence in the water, turbidity of the water, and/or typically few visual features present to image, have resulted in unreliable solutions which have not been commercially adopted.

Structures which are submerged in a body of water, such as a lake, river or ocean, develop fouling over time. Fouling is due to the accumulation of live organisms (biofouling) or non-live substances attaching to surfaces of the structure. If left unattended, fouling degrades the surfaces causing irreversible damage and potentially resulting in mechanical failure of the structure.

Fouling of a vessel's hull is a significant problem as degradation of hull surfaces increase friction between the hull and water. This increases fuel consumed by the vessel during transit, frequency of hull maintenance, and likelihood of mechanical failure of the hull. Proper management of hull fouling involves periodic removal of the fouling (hull cleaning) additionally or alternatively to applying antifouling paint to the hull. Fouling removal often requires removing the vessel from the water, requiring lifting apparatus such as a crane, or a dry dock, to allow manual removal of fouling with tools and/or pressurised water cleaners. Alternatively, vessel hulls are cleaned in-situ by persons diving underwater to manually clean the hull. Both approaches are time consuming, potentially dangerous, restricted by environmental regulation and expensive, particularly where removal of the vessel from the water is required.

Various automated, or semi-automated, systems for cleaning the hulls of vessels, generally intended for cleaning commercial vessels, are known. The majority of such systems are based on a cleaning device ‘crawling’ across the hull to remove fouling, where the device is pressed against the hull, typically by a suction or similar mechanism, or retained on the hull by magnetic wheels, and operated to remove fouling with brushes and/or jets of pressurised water. However, such systems often prove unreliable due to losing contact with the vessel and requiring guidance to restore contact with the hull, some systems even requiring a diver to manually reposition the device on the hull, which is inefficient. Crawling-type systems are also unable to traverse or access particular geometries, such as compound curved surfaces, meaning that the utility of such systems can be limited. Furthermore, the complexity, size and cost of many known systems mean that these are generally impractical and/or cost prohibitive for use by private vessel owners.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

Disclosed is an underwater vehicle for navigating relative to a structure submerged in a body of water. The vehicle includes: a body having an operatively front, rear, opposed sides, top and bottom, and defining a peripheral region bounding the front, rear, and opposed sides; one or more drive mechanisms carried by the body; a plurality of imaging modules carried by the body to face away from the peripheral region; and a controller communicatively coupled with the plurality of imaging modules and the one or more drive mechanisms. The plurality of imaging modules are configured to operate concurrently to allow imaging at least partially about at least two of the front, opposed sides, top and bottom of the body. The controller is configured to control operation of the one or more drive mechanisms to navigate the vehicle about the structure based on images captured by the plurality of imaging modules. Navigation may be based on feature recognition in the images, such as by the controller executing one or more image analysis algorithms. The controller may be further configured to control the operation of the one or more drive mechanisms based on the output of one or more other sensors carried by or associate with the vehicle and which are operable to sense a parameter of the vehicle or environment local to the vehicle.

The controller may be configured to determine at least one of a position and orientation of the vehicle relative to the structure based on the images captured by the plurality of imaging modules, and to control operation of the one or more drive mechanisms to navigate the vehicle about the structure based on at least one of the position and orientation of the vehicle relative to the structure.

The imaging modules may be arranged by the body such that a first imaging module faces away from the front portion, and a pair of second imaging modules face away from each of the opposed side portions.

The body may define a notional plane, and at least some of the imaging modules be configured to face at a defined angle transverse to the plane to allow imaging about an operatively top portion or bottom portion of the body at one side of the notional plane.

Each of the first and second imaging modules may be arranged to face at the defined angle to allow concurrent imaging at least partially about the front portion, the opposed side portions, and the top portion. The defined angle of the first imaging module may be different to the defined angle of the second imaging modules.

At least one of the imaging modules may be arranged to face perpendicularly to the notional plane to image about the top portion of the body.

The controller may be configured to control operation of the one or more drive mechanisms to position the notional plane relative to the structure based on the images captured by the imaging modules arranged at the defined angle relative to the notional plane.

The body may carry an interaction module for interacting with the structure, and at least one of the imaging modules may be configured to face at the defined angle to allow imaging adjacent the interaction module, and the controller may be configured to control operation of the one or more drive mechanisms to position the interaction module relative to the structure based on the images captured by the at least some of the imaging modules.

The interaction module may define an elongate structure defining a first end and an opposed second end, and be adjustably mounted to the body to allow positioning the second end to extend past the peripheral region to allow interacting with the structure. In such embodiments, the interaction module may be mounted to the body to allow at least one of displacing the interaction module in a linear direction relative to the body, and rotating the interaction module about at least one axis.

The interaction module may be configured for cleaning the structure, and the interaction module may include at least one rotatable brush at the second end. The interaction module may be releasably mounted on the body to allow replacing with an alternatively configured interaction module, such as configured for inspection, testing, maintenance, or other manipulation of the structure.

The body may carry a pair of the interaction modules to be spaced apart from each other, and at least one of the imaging modules may be arranged between the interaction modules to face perpendicularly to the plane. The at least one imaging module may comprise a pair of stereo cameras.

At least one of the imaging modules may be mounted to the body by an adjustment mechanism operable to adjust the defined angle.

Each of the imaging modules may be operable to define a field of view, and the field of view of at least two of the imaging modules may overlap. The at least two of the imaging modules may be arranged such that the fields of view overlap to allow concurrently imaging at the at least two of the front, opposed sides, top, and bottom of the body.

At least one of the imaging modules may comprise a stereo pair of cameras. The cameras of the stereo pair may be arranged to be angled towards each other.

At least one of the imaging modules may be covered by a domed lens, typically forming a housing over the at least one module. At least one of the imaging modules may be covered by other specific lenses having geometry configured for underwater imaging, such as a wet lens.

The vehicle may also include a plurality of range sensors carried by the body to be spaced from each other, each range sensor operable to determine distance of an object relative to the body, and the controller be communicatively coupled with the range sensors and configured to control operation of the one or more drive mechanisms based on distance data received from the range sensors.

The range sensors may be arranged about the body to face away from the peripheral region and allow measuring distance relative to the front, opposed sides, and/or top of the body.

The body may carry at least one interaction module for interacting with the structure and further include a plurality of range sensors carried by the body to be spaced from each other, each range sensor operable to determine distance of an object relative to the body, and the controller be communicatively coupled with the range sensors and configured to control operation of the one or more drive mechanisms to position the interaction module relative to the structure based on at least one of the images captured by the imaging modules, and distance data received from the range sensors, and further configured to operate the at least one interaction module. In such embodiments, a pair of the interaction modules may be spaced from each other, each interaction module including at least one rotatable brush, and the controller be configured to control operation of each interaction module to rotate the at least one brush based on at least one of the images captured by the imaging modules, and distance data received from the range sensors.

The vehicle may include a plurality of light emitters carried by the body and spaced from the imaging modules, each light emitter operable to illuminate a field of view of at least one imaging module, and the controller be communicatively coupled with the light emitters and configured to control operation of the light emitters.

At least some of the light emitters may be configured as elongate light bars operable to illuminate along a linear length, where at least one light bar is arranged to extend between the opposed sides of the body to illuminate about the top of the body, and a pair of the light bars are spaced from each other to extend along, and illuminate about, the opposed sides of the body.

At least some of the light emitters may be configured as spot lights operable to emit a narrow beam of light, where at least one spotlight is arranged to illuminate about the top of the body, and at least one spot light is arranged to illuminate about the front of the body.

The controller may be configured to control operation of the light emitters based on images captured by the plurality of imaging modules.

The vehicle may include a plurality of range sensors carried by the body to be spaced from each other, each range sensor operable to determine distance of an object relative to the body, and a plurality of light emitters carried by the body and spaced from the imaging modules, each light emitter operable to illuminate a field of view of at least one imaging module, and the controller be communicatively coupled with the range sensors and the light emitters and further configured to control operation of the one or more drive mechanisms based on distance data received from the range sensors, and configured to control operation of the light emitters based on one or more of: images captured by the plurality of imaging modules; distance data received from the range sensors; and estimated position and/or orientation of the vehicle relative to the structure.

The controller may be configured to control operation of the light emitters to adjust one or more of brightness, colour temperature, and strobe frequency of illumination.

The controller may include a processor, or more than one processor, sealably contained within the body. The controller may be configured to effect autonomous navigation relative to the structure.

The vehicle may include a base station mounted outside of the body of water, and a tether connecting the body to the base station. The base station may be mounted at a fixed position relative to the water, or may be carried by a structure floating on the water. The tether may be configured to provide mechanical and/or electrical connection between the body and the base station. The tether may be associated with a drive mechanism operable to adjust the effective length of the tether, such as by winding the tether about a spool, to cause the vehicle to be deployed into, or removed from, the water. The tether may be configured to supply power to one or more batteries arranged onboard the vehicle, and/or communicate data between the vehicle and a server, such as located at the base station, and/or hosted remotely and accessed via the Internet.

Also disclosed is an underwater vehicle configured to clean a structure submerged in a body of water. The vehicle includes: a body defining a peripheral region; and an elongate cleaning module operable to clean the structure, the cleaning module defining a first end and an opposed second end, the cleaning module being adjustably mounted to the body to allow at least one of displacing the cleaning module in a linear direction relative to the body, and rotating the cleaning module about at least one axis, to position the second end to extend past the peripheral region to access the structure.

The cleaning module may define a longitudinal axis between the ends and includes a first brush arranged at the second end and rotatable about the longitudinal axis. The cleaning module may further include a second brush rotatable about the longitudinal axis and spaced axially from the first brush, the first brush and the second brush being rotatable independently of each other.

The body may define a notional plane extending across the peripheral region, and the cleaning module be carried by the body at one side of the plane to be at an operatively top or bottom of the body.

A further cleaning module may be carried by the body at the one side of the plane and spaced from the cleaning module, the further cleaning module defining an axis and having at least one brush rotatably mounted about the axis. The further cleaning module may have a pair of brushes rotatably mounted about the axis and configured to rotate independently of each other.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Embodiments will now be described by way of example only with reference to the accompanying drawings in which:

FIG. 1 shows a front perspective view of an underwater vehicle for navigating relative to a structure submerged in a body of water;

FIG. 2 shows a top view of the vehicle shown in FIG. 1;

FIG. 3 shows a front view of the vehicle shown in FIGS. 1 and 2;

FIG. 4 shows a front schematic view of imaging modules carried by the vehicle shown in FIGS. 1 to 3;

FIG. 5 shows a side schematic view of the imaging modules shown in FIG. 4;

FIGS. 6A and 6B shows perspective views of the vehicle shown in FIGS. 1 to 3 configured for interaction with the underwater structure;

FIGS. 7A and 7B show a schematic top perspective view and top view, respectively, illustrating fields of view defined by imaging modules carried by the vehicle shown in FIGS. 1 to 3;

FIGS. 8A and 8B show a schematic top perspective view and top view, respectively, illustrating fields of view defined by the imaging modules carried by the vehicle shown in FIGS. 1 to 3, where the imaging modules are arranged such that the fields of view are in an overlapping configuration;

FIGS. 9A and 9B show schematic top views of the vehicle shown in FIGS. 1 to 3, illustrating fields of view of the imaging modules, where each module is covered by a planar port (FIG. 9A) or a domed port (FIG. 9B);

FIG. 10 is a perspective view of the vehicle shown in FIGS. 1 to 3 illustrating positions of range sensors; and

FIG. 11 is a perspective view of the vehicle shown in FIGS. 1 to 3 illustrating positions of light emitters.

### DESCRIPTION OF EMBODIMENTS

Applicant's International Patent Application Publication Number WO 2021/026589 describes a system for cleaning a structure arranged in a body of water, the system including a vehicle operable to move through water, a tether connectable between the vehicle and a fixed position, and a deployment mechanism securable relative to the structure and operable to move the vehicle into, our out of, the water, the content which is incorporated herein by reference in its entirety.

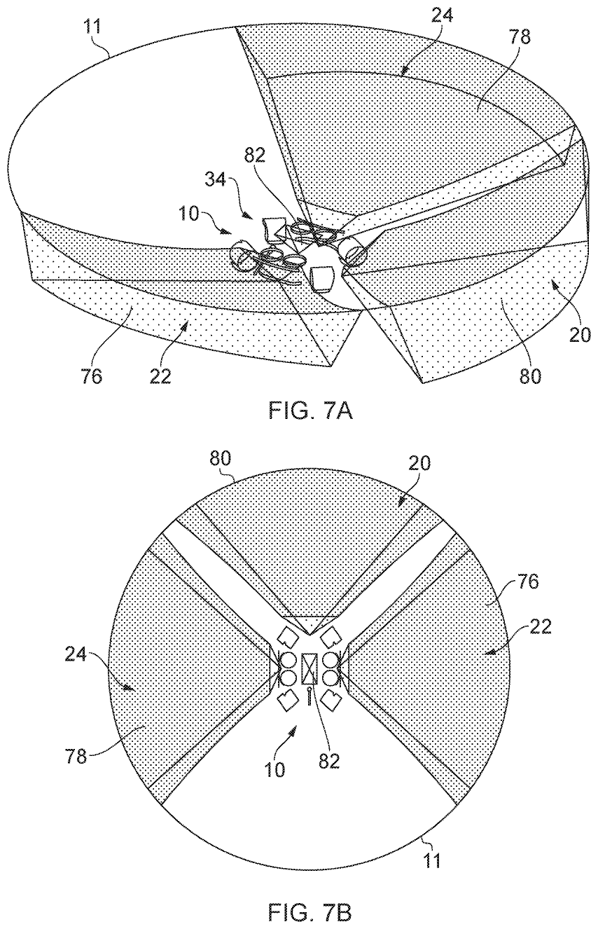

In the drawings, reference numeral 10 designates an underwater vehicle 10 for navigating relative to a structure 11 (FIG. 7A) submerged in a body of water. The vehicle 10 includes a body 12 having an operatively front 20, rear 25, opposed sides 22, 24, top 34 and bottom 35, and defining a peripheral region 14 bounding the front 20, rear 25, and opposed sides 22, 24. One or more drive mechanisms 16 are carried by the body 12. The vehicle 10 also includes a plurality of imaging modules 18 carried by the body 12 to face away from the peripheral region 14. The plurality of imaging modules 18 are configured to operate concurrently to allow imaging at least partially about at least two of a front 20, opposed sides 22, 24, top 34 and bottom 35 of the body 12. The vehicle 10 also includes a controller 26 communicatively coupled with the plurality of imaging modules 18 and the one or more drive mechanisms 16, the controller 26 configured to control operation of the one or more drive mechanisms 16 to navigate the vehicle 10 about the structure based on images captured by the plurality of imaging modules 18.

The vehicle 10 is configured to allow precise localisation and navigation relative to a structure defined by, or associated with, a vessel submerged in the body of water, e.g. a boat. In some embodiments, the vehicle 10 is also operable to clean the vessel and associated structures, such as a hull (not shown), keel (not shown), propellers (not shown), chains (not shown), and the like. Typically the vehicle 10 is secured to the vessel, such as by a tether (not illustrated), to allow communicating electrical power from a power supply to the vehicle 10, as well as retracting the vehicle 10 towards the vessel and lifting the vehicle out of the water, for example, should power be lost or the vehicle not be in use. In some embodiments, the vehicle 10 is secured to part of a dock, such as a jetty (not shown), and is operable to navigate relative to boats in a harbour and/or the jetty. Similarly, the vehicle 10 may be secured to a static structure, such as an oil rig platform (not illustrated) is operable to navigate relative to the platform, such as to allow inspection and/or conducting maintenance.

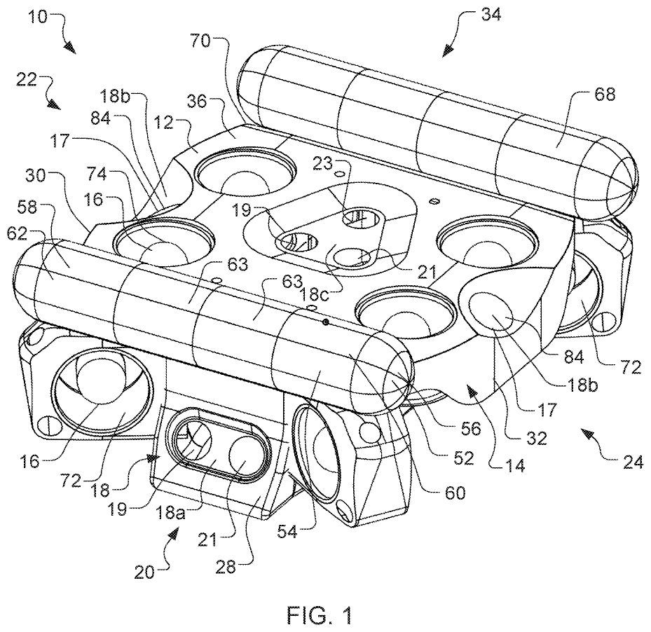

Referring to FIGS. 1 to 3, the imaging modules 18 are shown arranged by the body 12 such that a first imaging module 18a faces away from the front 20, and a pair of second imaging modules 18b face away from each of the opposed sides 22, 24. In this embodiment 10, the first imaging module 18a and the pair of second imaging modules 18b are mounted to the body 12 to allow concurrently imaging about opposed sides 22, 24 of the body 12.

It will be appreciated that the illustrated arrangement of the imaging modules 18 about the body 12 is exemplary and that the vehicle 10 is alternatively configurable to have more, or less, imaging modules 18. It will also be appreciated that the modules 18 may be alternatively arranged by the body 12 to face at least partially away from the peripheral region 14 and allow concurrent imaging about at least two of the front 20, opposed sides 22, 24, top 34, and bottom 35 of the body 12.

For example, in some embodiments (not illustrated), the first imaging module 18a is omitted and the pair of second imaging modules 18b are each configured to have a field of view (FOV) wide enough to image about one of the opposed sides 22, 24 and at least partially about the front 20 of the body 12. In some embodiments, each of the second imaging modules 18 b defines a FOV of approximately 180 degrees. In this configuration, the pair of second imaging modules 18b are operable to image at least partially about the front 20 and concurrently image each of the opposed sides 22, 24 of the body 12.

In further embodiments (not illustrated), the body 12 carries an annular array of imaging modules 18 where each module 18 is arranged to face radially outwards from the peripheral region 14. For example, some embodiments may include eighteen, or thirty-six, evenly spaced imaging modules 18 in the annular array to allow concurrent imaging entirely around the peripheral region 14. In yet other embodiments, some of the modules 18 in the annular array are directed away from the peripheral region 14 and partially towards the top 34 of the body 12, to allow imaging about the top 34, and other modules 18 in the array are directed away from the peripheral region 15 and partially towards the bottom 35 of the body 12, to allow imaging about the bottom 35.

In the illustrated embodiment 10, a third imaging module 18c is carried by the body 12 and configured to operate concurrently with the first imaging module 18a and the pair of second imaging modules 18b to allow concurrent imaging about the front 20, sides 22, 24, and the top 34 of the body 12. It will be appreciated that, in other embodiments, the third imaging module 18c may be omitted where imaging operatively above the vehicle 10 is not required, or arranged in, or otherwise facing away from, the bottom 35 of the body 12 where imaging operatively below the vehicle 10 is required.

Each of the plurality of imaging modules 18 includes at least one optical camera 17, and at least one of the imaging modules 18 is configurable to include a stereo pair of cameras 19, 21, for example, the first imaging module 18a and the third imaging module 18c, to assist with resolving the depth of an object in the field of view of the at least one of the imaging modules 18. The third imaging module 18c includes a third camera 23 for imaging the surface of the structure from a short distance, for example, to allow visual inspection to identify fouling on the structure, and monitor the progress of fouling removal as the structure is being cleaned. Each camera 17 is typically configured to record images using a conventional visible light-based RGB sensor and may additionally, or alternatively, include an infrared or other light-based sensor. The third camera 23 is typically configured to capture high resolution images or video to allow detailed inspection of structures, such as boat hulls or seabeds, and/or allow photogrammetry reconstructions. It will be appreciated that, in some embodiments (not illustrated), the third imaging module 18c may be arranged to face away from the bottom 35 to image operatively under the vehicle 10.

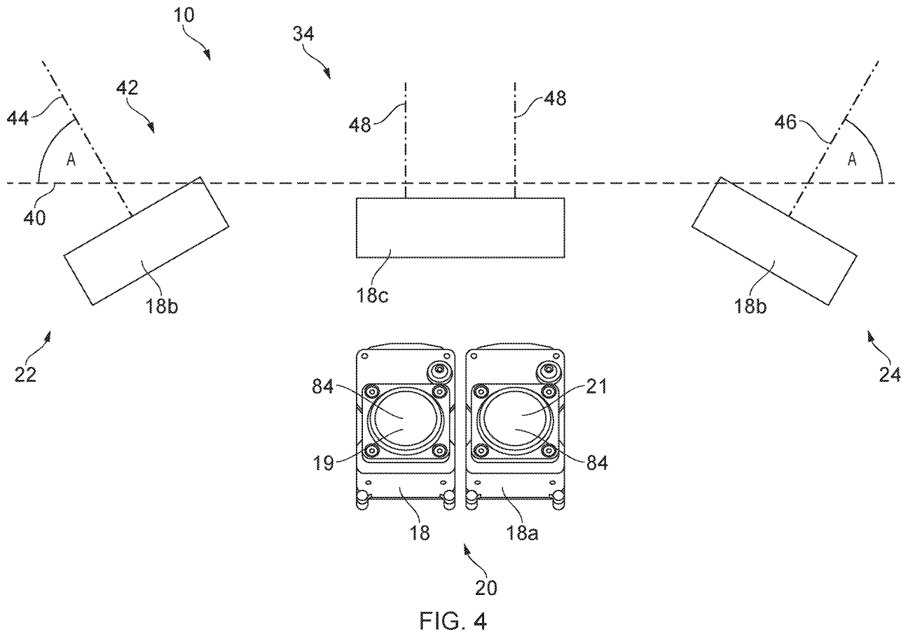

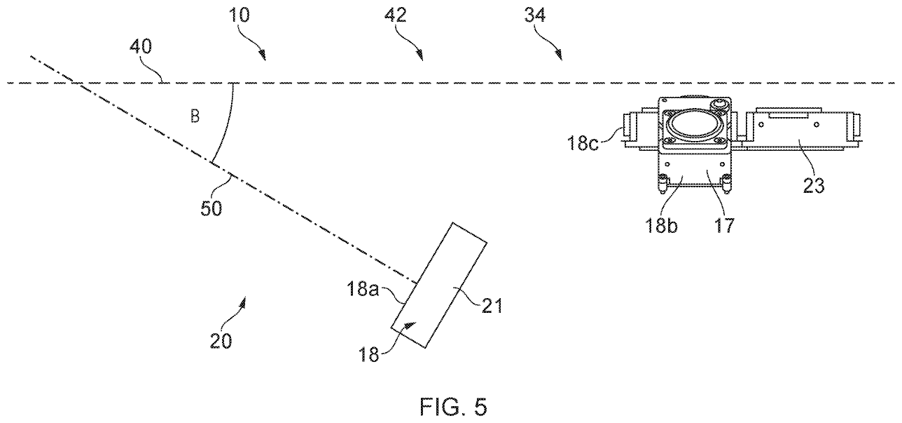

The body 12 defines a notional (virtual) plane 40 between the front 20 and opposed sides 22, 24, and at least some of the imaging modules 18 are configured to face at a defined angle transverse to the plane 40. This arrangement of the module 18 allows operating modules 18 to image at one side 42 of the notional plane 40, being above or below the vehicle 10. Best shown in FIGS. 4 and 5, and discussed further below, in the illustrated embodiment 10, some of the imaging modules 18a, 18b are arranged at the defined angle to image operatively above the vehicle 10, i.e. adjacent the top 34 of the body 12. The notional plane 40 may be defined by at least three points of the body 12, such as defined at the top portion 36. FIGS. 4 and 5 show the spaced relationship of the plurality of imaging modules 18 without showing the body 12 to more clearly illustrate the defined angle of the plurality of imaging modules 18 with reference to the plane 40.

Referring to FIG. 4, being a front view schematic of the imaging modules 18, the defined angle faced by each of the second imaging modules 18b relative to the plane 40 is shown by the line of sight 44, 46 of each of the imaging modules 18b intersecting the plane 40 at the defined angle, identified as “A”. The defined angle may be any suitable angle greater than 0 and less than 90 degrees, typically being between 30 and 75 degrees to provide a balance of imaging away from the peripheral region 14 and above the body 12. It will be understood that the defined angle of each of the pair of second imaging modules 18b may be the same or different to each other. The third imaging module 18c is arranged to face perpendicularly to the plane 40 as shown by the line of sight 48 of the imaging module 18c, and it will be understood that further imaging modules 18 may be included which also face perpendicularly to the plane 40.

Referring to FIG. 5, being a side view schematic of the imaging modules 18, the defined angle faced by the first imaging module 18a relative to the plane 40 is shown by the line of sight 50 of the imaging module 18a intersecting the plane 40 at the defined angle, identified as “B”. The defined angle may be any suitable angle greater than 0 and less than 90 degrees, typically between 10 and 60 degrees to provide a balance of imaging away the peripheral region 14 and above the body 12. In this embodiment, the defined angle B faced by the first imaging module 18a is less than the defined angle A faced by the pair of second imaging modules 18b in order to encompass less of the space adjacent the top 34 of the body 12 in its field of view compared to the pair of second imaging modules 18b. It will be understood that none of the plurality of imaging modules 18 may face at an angle that intersects the plane 40, that is, all of the plurality of imaging modules 18 may face directly away from the peripheral region 14 in a direction parallel to the plane 40. In such an embodiment, some or all of the plurality of imaging modules 18 may optionally have a sufficiently wide field of view so as to at least partially image the space adjacent the top 34 of the body 12.

In the illustrated embodiment 10, each of the plurality of imaging modules 18 are fixedly mounted to the body 12 such that the defined angle is fixed. In some embodiments (not illustrated), at least one of the imaging modules 18 is mounted to the body 12 by an adjustment mechanism (not shown) operable to adjust the defined angle, for example, by having a lockable ball and socket mount, or having a gimbal-type mount operable to rotate the imaging module 18 about at least one axis. It will be appreciated that the controller 26 may be communicatively coupled with the adjustment mechanism to allow selectively orientating the imaging module 18 relative to the notional plane 40.

The illustrated vehicle 10 includes an interaction module 52 configured for interacting with the structure. The top portion 36 of the body 12 carries the interaction module 52, configured as a cleaning module configured for cleaning the structure. The module 52 defines an elongate structure 54 defining a first end 56 and an opposed second end 58, and a longitudinal axis 55 between the ends 56, 58. The interaction module 52 includes at least one rotatable brush for cleaning the structure, and in the illustrated embodiment, the first end 56 has a first brush 60 rotatably mounted about the axis 55 and the second end 58 has a second brush 62 rotatably mounted about the axis 55 and spaced axially from the first brush 60. The first and second brushes 60, 62 are typically rotatable independently of each other via the controller 26. The brushes 60, 62 are each mounted to a spindle (not shown) of the elongate structure 54 and each may include comprise bristle or resiliently flexible tabs (not shown). The interaction module 52 includes two further brushes 63 rotatably mounted about the axis 55 and positioned axially along the spindle between the outer brushes 60, 62. The brushes 63 are typically configured to rotate together with the adjacent outer brush 60, 62.

It will be understood that the interaction module 52 is configurable for alternative interactions with the structure, such as gripping, cutting, drilling, probing/measuring with a sensor, or imaging, such as with a 3D scanner. Furthermore, the interaction module 52 may be configured for cleaning the structure by polishing, scraping, abrading, sanding, and the like, such as by alternatively configuring the surface texture or bristles of the brushes 60, 62, 63. It will also be understood that the number of brushes may vary in other embodiments, for example, the interaction module 52 may include one, two, three, four, or greater than four brushes. Typically, the interaction module 52 is releasably engaged with the body 12 to readily allow removal and replacement with another, alternative interaction module 52, such as to allow providing a different function and interaction.

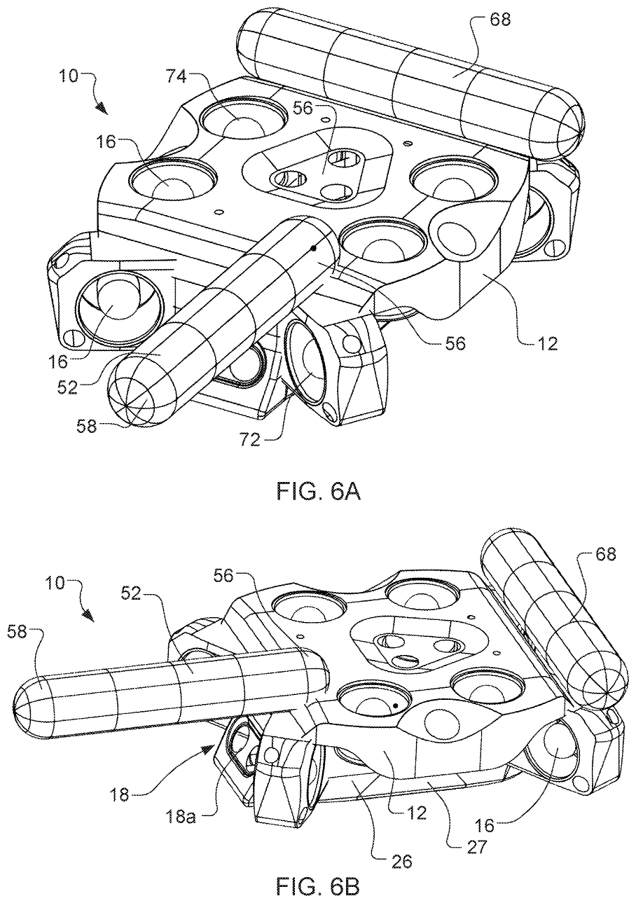

Best shown in FIGS. 6A and 6B, optionally, the interaction module 52 is adjustably mounted to the body 12 to allow pivoting about an axis adjacent the first (pivot) end 56 to allow pivoting the second (free) end 58 to extend past the peripheral region 14 of the body 12 to allow interacting with the structure. In the illustrated embodiment 10, the interaction module 52 includes a bracket 64 mounted to an electric motor (not shown) contained in the body 12 via a pin joint 66 which allows the interaction module 52 to pivot and extend past the peripheral region 14. This extended or ‘jousting’ configuration of the interaction module 52 allows the interaction module 52, and particularly the free end 58, to interact with target portions of the submerged structure, or with portions of the structure located above the water line, by urging the interaction module 52 into the target portions. The extended configuration of the interaction module 52 can be useful to comprehensively access target portions which include concave, or other complex geometry, structures, or access through apertures or into recesses dimensioned to be less than the peripheral region 14.

It will be appreciated that, in other embodiments (not illustrated), the interaction module 52 is mounted to allow sliding in one or more linear directions relative to the body 12, and/or pivoting relative to the body 12 about two, or more, axes. In some embodiments (not illustrated), the module 52 is mounted to the body 12 by a mechanism configured to pivot about an axis arranged substantially mid-way across the front of the body 12, and then displace the module 62 linearly away from the peripheral region 14. Such embodiments may be useful to limit force exerted through the pivot axis during use.

At least one of the imaging modules 18, in the illustrated embodiment being the first module 18a, is configured to face at the defined angle to allow imaging adjacent the interaction module 52. The first imaging module 18a is mounted to the body 12 at an operatively lower position compared to the second and third imaging modules 18b, 18c in order to include at least a majority of the interaction module 52 in its field of view, as well as the front 20, and optionally the top 34, of the peripheral region 14. In this way, the interaction module 52 in both its aligned (FIGS. 1 to 3) and extended (FIG. 6) configurations may be monitored by the first imaging module 18a.

In the illustrated embodiment 10, the top portion 36 of the body 12 carries a pair of the interaction modules 52, 68 spaced apart from each other. One of the interaction modules 68 has the same features as the other interaction module 52 and is carried proximate the rear portion 34 of the body 12 by being fixedly mounted to the body 12, and the other interaction module 52 is carried proximate the front portion 28 of the body 12. At least one of the imaging modules 18 is arranged between the interaction modules 52, 68 to face perpendicularly to the plane 40, which in this embodiment is the third imaging module 18c. The imaging module 18c is operable to include both of the interaction modules 52, 68 and the structure in its field of view in order to image one, or both, of the interaction modules 52, 68 interacting with the structure.

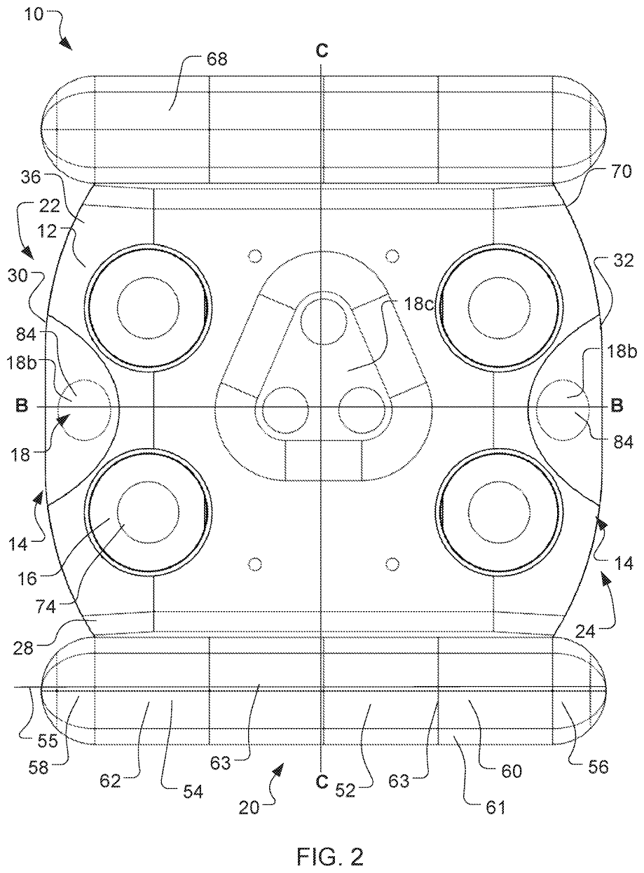

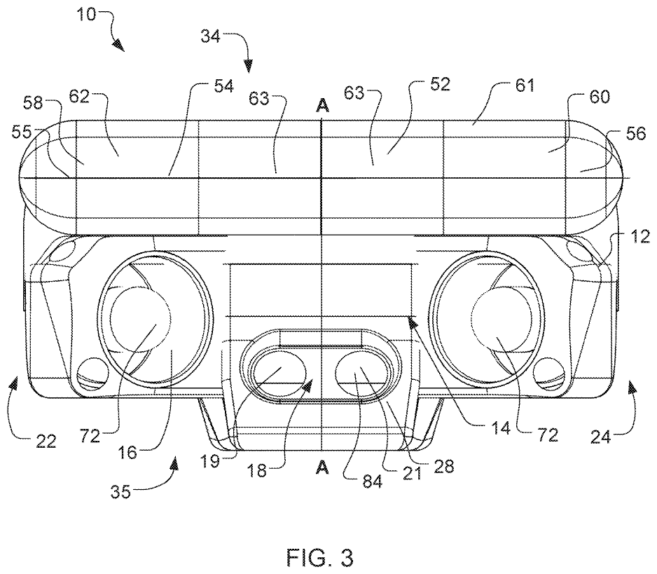

Referring to FIGS. 1 to 3 and 6, the drive mechanisms 16 include ducts which house eight thrusters 72, 74 rotatable by electric motors (not illustrated). The ducts are arranged such that operation of the thrusters 72, 74 enables moving the vehicle 10 freely in three-dimensional space through the water, in a swimming-type motion. Four of the ducts position some of the thrusters 72 about the periphery of the body 12 to allow rotation of the body 12 about a yaw axis A (FIG. 3) and translate the body 12 in a forwards, reverse and sideways direction. The other four ducts position the other thrusters 74 to allow rotation of the body about a pitch axis B and roll axis C (FIG. 2) and translate the body along the yaw axis A to adjust depth. The arrangement and operation of the thrusters 72, 74 allows unrestricted propulsion of the vehicle 10 through the water, and can enhance precise control of the vehicle's position and/or orientation relative to a structure, and/or enhance accessing complex geometry structures.

The controller 26 is connected to the drive mechanisms 16 to effect translation and/or rotation of the body 12 to navigate the vehicle 10 relative to the structure. In some embodiments, the controller 26 is configured to estimate or determine at least one of a position and orientation of the vehicle 10, or determine pose of the vehicle 10, relative to the structure based on the images captured by the plurality of imaging modules 18, and to control operation of the one or more drive mechanisms 16 to navigate the vehicle 10 about the structure based on the determined position and/or orientation of the vehicle 10. In the illustrated embodiments, the controller 26 includes one or more processors (not shown) sealably contained within the body 12 and operable to determine position and orientation of the vehicle 10 relative to the structure, and operate the thrusters 72, 74 as a result. In other embodiments (not illustrated), the vehicle 10 includes only a single drive mechanism operable by the controller 26 to navigate the vehicle 10 through the water, for example, a thruster rotatably mounted to the body 12 about two axes.

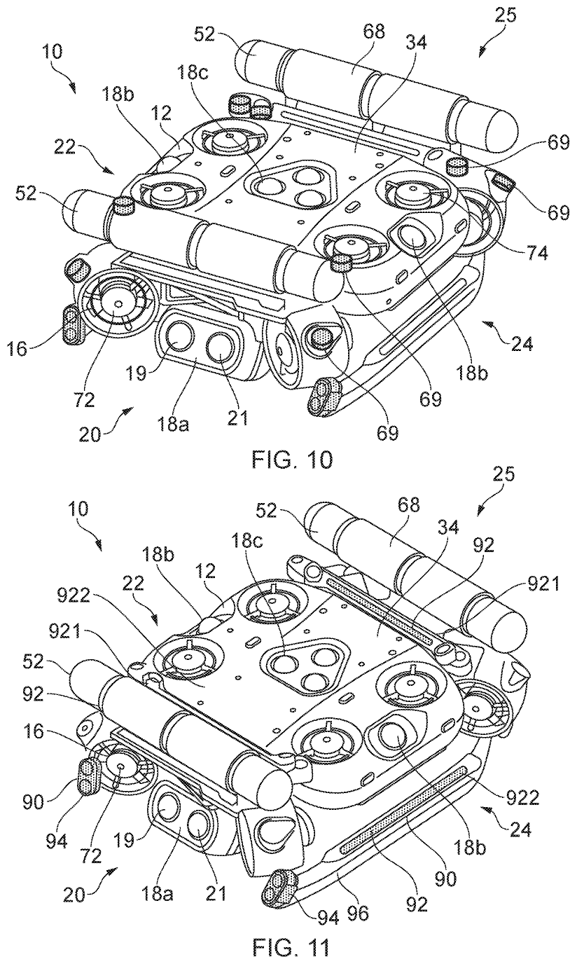

Best shown in FIG. 6B, the body 12 defines, or carries, a sealed container 27 housing the controller 26 and other electronic components. The body 12 may also carry a range of sensors within the container 27, or external to the container 27 and communicatively coupled to the controller 26, including any of ultrasonic sensors, a barometer, hall effect sensors, temperature sensors, force and/or current sensors operatively connected to the interaction modules 52, 68 and/or the tether, and inertial measurement units (IMUs) which may be connected to one or more of the plurality of imaging modules 18 in order for the plurality of imaging modules 18 to provide visual inertial odometry for navigating the vehicle 10. In the illustrated embodiment and best shown in FIG. 10, the body 12 also carries an array of range sensors 69 arranged at the front 20 and/or each corner of the body 12, and communicative coupled with the controller 26. As described in greater detail below with reference to FIG. 10, the range sensors 69 are operable to allow determining any of distance of the body 12 from the submerged structure, orientation of the body 12 relative to the structure, and angle offset of planes. The controller 26 is configured to communicate with any of these sensors to allow receiving multi-modal sensed information.

The position and orientation of the vehicle 10 is generally estimated or determined by the controller 26 by calculation based on outputs from the plurality of imaging modules 18. This may also include incorporating data received from the one or more sensors on board the vehicle 10, and/or tracking the inputs and outputs of the drive mechanisms 16 and referring to a point in space corresponding to the point from which the vehicle 10 is launched. In some embodiments, the controller 26 is not configured to determine position, orientation, or pose of the vehicle 10 relative to the structure 11 or other reference frame, and instead, the controller 26 is configured to control the drive mechanisms 16 to move the vehicle 10 such that a feature of the structure remains within a predetermined pixel size range as captured by the plurality of imaging modules 18. Such an embodiment of the controller 26 may employ feature detection from the images captured by the plurality of imaging modules 18.

The controller 26 may be configured to control operation of one or more of the drive mechanisms 16 to position the notional plane 40 relative to the structure based on the images captured by the imaging modules 18 arranged to face at the defined transverse angle relative to the notional plane 40. For example, in the illustrated embodiment 10, the notional plane 40 is parallel to the top portion 36 of the body 12, meaning that operating the drive mechanisms 16 in this way allows urging the top portion 36, and consequently the interaction modules 56, 68, towards the submerged structure. In embodiments where at least one of the imaging modules 18 is configured to face at the defined angle to allow imaging adjacent the interaction module 52, for example, the first imaging module 18a, the controller 26 may be configured to control operation of the one or more drive mechanisms 16 to position the interaction module 52 relative to the structure based on the images captured by the imaging modules 18 arranged to face at the defined angle.

It will be understood that the vehicle 10 may be an unmanned underwater vehicle and the controller 26 be configured to effect autonomous localization and navigation of the vehicle 10 relative to the structure 11. It will also be understood that the vehicle 10 may be a semi-autonomous vehicle allowing a user to override the controller 26 and manually remotely control the vehicle 10, such as to navigate past an obstacle. In other embodiments, the controller 26 may not be fully carried by the vehicle 10, for example, the controller 26 may be in a master/slave configuration and comprise a primary controller (not shown) located remotely from the body 12, and a secondary controller sealably contained within the body 12 and configured to transmit the images captured by the plurality of imaging modules 18 to the primary controller. The primary controller may be configured to transmit a command to the secondary controller to control operation of the one or more drive mechanisms 16 to navigate the vehicle 10 about the structure based on the images received from the secondary controller.

The controller 26 may be operable to determine a fouling or other condition of the structure. This may involve assessing data collected by sensors arranged in or on the vehicle 10, such as force sensors associated with the interaction modules 52, 68, and/or images captured by the plurality of imaging modules 18. Responsive to determining the fouling condition, the controller 26 may be configured to adjust a cycle period of the vehicle 20 so that the vehicle 10 cleans the structure sufficiently frequently to prevent fouling being established. The controller 26 may also include a cycle period timer that defines a time period equivalent to the cycle period minus the duration of the previously executed cleaning schedule (or a default value when first operated). When the timer has elapsed, this causes the controller 26 to repeat the cleaning schedule by re-initiating the schedule.

In other embodiments, the processing may be performed by a remote server and communicated to the controller 26 via a wide area network or local area network. In further embodiments, the controller 26 includes at least one first processor carried by the vehicle 10, and at least one second processor located above water, to allow processing by a combination of on-board and off-board (remote) processors. In this way, the processing of the images from the plurality of imaging modules 18 is not entirely implemented on-board the vehicle 10, which can limit computational power required to to be provided by the vehicle 10 itself. This can decrease the energy cost and weight of the vehicle 10, and, as a result, enhance electrical and kinematic efficiency. Generally, image processing is performed by a processor of the controller 26 carried on-board the vehicle 10 to limit latency, which can enhance navigational accuracy and/or responsiveness.

In other embodiments, the controller 26 is not carried by the body 12 and instead is located above water, for example, within a base station, such as a garage (not shown), mounted outside of the body of water that is configured to house the vehicle 10 when not in use. The base station may be fixedly mounted relative to the water, such as to a marina or other structure adjacent the water, or be mounted to a structure floating on the water, such as a boat or pontoon. In such embodiments, a tether (not shown) may be provided connecting the body 12 to the base station. The tether is configured to provide mechanical connection, and may also provide electrical connection, between the body 12 and the base station. The tether allows a drive mechanism to adjust the effective length of the tether, for example, to cause withdrawing the vehicle from the water for storage or maintenance. The tether typically connects the vehicle 10 to a power supply and is configurable to also communicate data between the vehicle and the base station, or a remote server such as accessed via the Internet. In some embodiments, the vehicle 10 is battery powered and require no such tether for mechanical or electrical connection to the base station.

The controller 26 may be communicatively connected to a deployment mechanism (not shown) via wired or wireless connection, which is configured to deploy the vehicle 10 from the base station, such as by unwinding a tether connected to the vehicle 10 from a spool, or by lowering a platform supporting the vehicle 10 into the water. The controller 26 may be configured to cause operation of the vehicle 10 and the deployment mechanism according to a predetermined cleaning schedule which is may be user-modified or generated by the controller 26 based on a geometry of the structure submerged in water. The deployment mechanism may be operable to deploy and recover the vehicle 10 from the water by adjusting an effective length of the tether. The deployment mechanism may also operate to reduce slack in the tether whilst the vehicle 10 is moving through the water around the structure.

In other embodiments, the controller 26 may be operatively connected to a communications module, typically being a wireless cellular network module, to allow communicating with a remote server via the Internet. Communicating with the remote server may allow, for example, uploading data captured by the vehicle 10 to enable monitoring of the vehicle 10 and/or analysis of the data, downloading software updates, operational instructions, and the like, and enables remote control of the vehicle 10 by a user, for example, to effect maintenance or resolve an error. Based on information from the remote server, the controller 26 may be configured to determine environmental conditions such as local water turbulence conditions, prevailing currents, wave height, and adjust the cycle period so that the vehicle 10 is deployed at appropriate times to avoid damage to the vehicle 10 and the structure.

The body 12 is dimensioned to be small-scale and sufficiently lightweight to be man-portable. A handle (not shown) may be defined at one side of the body 12 to assist manual transport of the vehicle 10 when out of the water. Lighting elements 90, such as shown in FIG. 11 and discussed in greater detail below, may also be secured to the body 12, for example, one or more first lighting elements may be arranged to illuminate adjacent the front 20 of the body 12 and one or more second lighting elements 90 may be arranged to illuminate adjacent the top 34 of the body 12. It will be appreciated that, in other embodiments (not shown), further lighting elements may be carried by the body 12 to illuminate about the sides 22, 24, and/or bottom 35 of the body 12, for example, to enhance the quality of images captured by the imaging modules 18, which consequently can enhance precision of control of the vehicle 10.

The fields of view 76, 78, 80, 82 defined by the plurality of imaging modules 18 are configurable in a number of different ways. These are discussed below with reference to FIGS. 7A-9B.

FIGS. 7A and 7B show schematic perspective and top views, respectively, of a first configuration of the fields of view 76, 78, 80, 82 of the plurality of imaging modules 18, where each field of view is shown as frustum extending away from the vehicle 10. In these figures, the vehicle 10 is located approximately 500 mm from the structure 11 submerged in water, the structure 11 representing a double-curved portion of a hull of a boat, and the intersection of each field of view 76, 78, 80, 82 is illustrated.

Best shown in FIG. 7A, the fields of view 76, 78, 80, 82 of the plurality of imaging modules 18 are directed to allow concurrent imaging of a space adjacent the front 20, the opposed sides 22, 24, and the top 34 of the body 12. The imaging modules 18 are arranged and configured so that the fields of view 76, 78, 80, 82 do not overlap in this configuration, meaning the controller 26 appends the fields of view 76, 78, 80, 82 together to form a combined field of view.

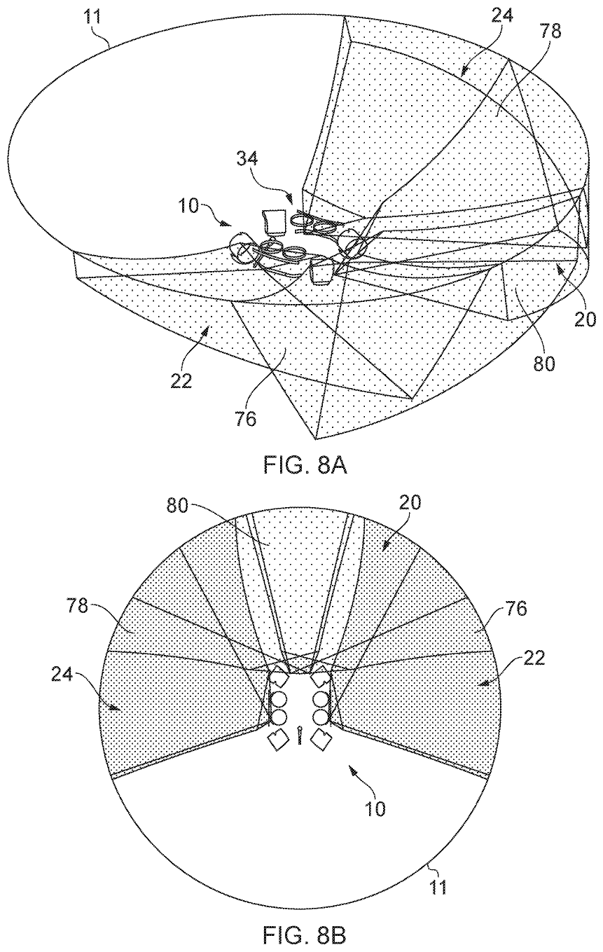

FIGS. 8A and 8B show schematic perspective and top views, respectively, of a second configuration of the fields of view 76, 78, 80 of the plurality of imaging modules 18, where each field of view is shown as frustum extending away from the vehicle 10. In these figures, the vehicle 10 is located approximately 500 mm from the structure 11 submerged in water, the structure 11 representing a double-curved portion of a hull of a boat, and the intersection of each field of view 76, 78, 80, 82 with the hull is illustrated. The field of view 82 of the third imaging module 18c is not shown in FIGS. 8A and 8B.

Best shown in FIG. 8A, the fields of view 76, 78, 80, 82 of the plurality of imaging modules 18 are directed to allow concurrent imaging of a space adjacent the front 20, the opposed sides 22, 24, and the top 34 of the body 12. The imaging modules 18 are arranged and configured so that the fields of view 76, 78, 80 are directed to overlap. This also involves the stereo pair of cameras 19, 21 of the first imaging module 18a being arranged to be angled towards each other so that the fields of view 76a, 76b of each of the stereo cameras 19, 21 overlap. In other embodiments, only one of the stereo cameras 19, 21 may be angled towards the other camera 19, 21 in order for their fields of view 76a, 76b to overlap. To enhance the extent of overlap, the second imaging modules 18b are arranged to be slightly directed towards the front 20 of the peripheral region 14.

In this configuration, imaging about at least the front 20 and opposed sides 22, 24 of the body 12 requires the controller 26 to register and/or align, and/or stitch together, two or more of the fields of view 76, 78, 80 to form a combined field of view. The stitching together of the fields of view 76, 78, 80 is more computationally intensive than appending the fields of view 76, 78, 80, 82 as required by the first configuration. However, the stitching together can allow forming a continuous or seamless combined field of view which can enhance imaging about the front 20 and opposed sides 22, 24 of the body 12. This combined field of view from the overlapping fields of view 76, 78, 80 may also allow for an object to be imaged by more than one of the plurality of imaging modules 18 simultaneously, which may assist in resolving the depth of the object from the vehicle 10, or otherwise enhance accuracy of positioning the vehicle 10 relative to the object.

It will be understood that the imaging modules 18 are configurable so that only some, not all, of the fields of view 76, 78, 80 overlap. For example, in some configurations only two of the fields of view 76, 78, 80 overlap, and in other configurations, the field of view 82 of the third imaging module 18c overlaps with one or more of the other fields of view 76, 78, 80. It will also be understood that in embodiments of the vehicle 10 where the imaging modules 18 are mounted to the body 12 by an adjustment mechanism, the adjustment mechanism may be operable to adjust the defined angle faced by the plurality of imaging modules 18 and thereby alter the configuration of one or more of the fields of view 76, 78, 80, 82 to alter the plurality of imaging modules 18 between the first (spaced) and second (overlapped) configuration.

In some embodiments, each imaging module 18 is covered by a flat (planar) port, and in other embodiments, at least one of the imaging modules 18 is covered by a domed port 84. In either arrangement, the port is typically formed from a transparent material to act as a lens to affect images captured by the imaging modules 18. Each port typically forms a housing over the associated imaging module 18.

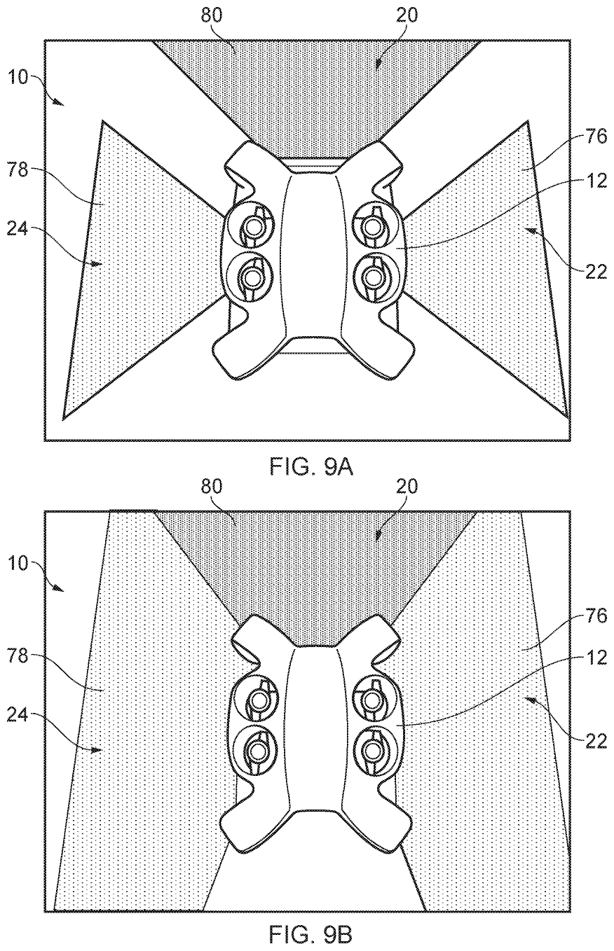

FIG. 9A shows a schematic top view of the vehicle 10 illustrating the fields of view 76, 78, 80 where the first and second imaging modules 18a, 18b are covered by the planar port. FIG. 9B shows a schematic top view of the vehicle 10 illustrating the fields of view 76, 78, 80 where the first and second imaging modules 18a, 18b are covered by a domed port 84. As shown in these figures, the configuration of the port can affect the extent (volume) of the fields of view 76, 78, 80, where the fields of view 76, 78, 80 cover a larger volume in the configuration of FIG. 9B compared to FIG. 9A. It will be appreciated that broadening the field of view can be achieved by alternative means, such as configuring each module 18 to include a specific lens.

FIG. 10 illustrates positioning of a plurality of range sensors 69 spaced across the body 12 to allow measuring distance to a complementary plurality of points spaced from the body 12. The controller 26 is communicatively coupled with each of the range sensors 69 and typically configured to control operation of the drive mechanisms 16, in this embodiment being the thrusters 72, 74, based on distance data received from the range sensors 69, such as to effect navigation of the vehicle 10 relative to the structure 11. The controller 26 is typically configured to control the drive mechanisms 16 based on the distance data in combination with analysis of the images captured by the imaging modules 18 however it will be appreciated that the controller 26 may select between, or both, of these sources to guide navigation of the vehicle 10, for example, depending on the local environmental conditions.

In the illustrated embodiment 10, the body 12 carries a first array of the range sensors 69 arranged about the peripheral region 14 at each corner between front 20 and side 22, 24, and between rear 25 and side 22, 24 of the body 12. The range sensors 69 of the first array may be directed at a transverse angle relative to the notional plane 40, such as shown in FIG. 10 where these range sensors 69 are partially directed towards the top 34 of the body 12. Operating these range sensors 69 allows measuring distance relative to the front 20, opposed sides 22, 24, and top 34 of the body. The body 12 also carries a second array of range sensors 69 spaced across the top 34 of the body 12, in this embodiment, being between the interaction modules 52 carrying the brushes 60, 62 to face directly away from the top 34. Operating these range sensors 69 allows measuring distance relative to the top 34 of the body. It will be appreciated that the illustrated arrangement of the range sensors 69 on the body 12 is exemplary and that other arrangements are possible, and may be useful, and that the body 12 may carry more, or less, sensors 69. The range sensors 69 are generally configured as infrared time-of-flight sensors however it will be appreciated that other range or distance sensors may be appropriate.

The arrangement of the range sensors 69 in the first array can usefully position the range sensors 69 at the extents of the body 12 and outside of the interaction modules 52 to have uninterrupted line of sight to an adjacent object, such as the hull 11 of a vessel, as shown in FIGS. 8A and 8B. Operating the range sensors 69 of the first array measures distance to an adjacent object. When the vehicle 10 is driven to be adjacent the structure 11, such as to clean the structure 11 with the brushes 60, 62, operating the first array of range sensors 69 can measure relative distance to a surface or edge of the structure 11 in front of and behind the vehicle 10, and can also detect the absence of the structure 11, such as due to travelling past an edge. Distance data generated by these measurements is processed by the controller 26 to effect adjusting control of the drive mechanisms 16 and/or adjusting control of the interaction modules 52, such as to enhance effectiveness and/or efficiency of cleaning the structure by rotating the brushes 60, 62.

The arrangement of the range sensors 69 in the second array can usefully position the range sensors 69 inboard of the interaction modules 52 to measure relative distance to a surface of the structure 11 adjacent, or touching, the modules 52, such as during a cleaning operation when operating the brushes 60, 62 pressed against the structure 11. As shown in FIG. 10, the sensors 69 may be positioned in a grid at four corners of the top portion 34 of the body 12. The distance data generated by these sensors 69 allows the controller to monitor spacing of the vehicle 10 from the structure 11.

The range sensors 69 may be arranged and operable so that distance data derived from one or both of the arrays allows the controller 26 to determine, or estimate, the geometry of an adjacent object, such as the structure 11, for example, to identify a boundary and/or shape of the structure 11. For example, operating the sensors 69 in the second array may allow determining, or estimating, a profile of a surface adjacent the top 34 of the vehicle 10 and, as a result, control operation of the drive mechanisms 16 and/or interaction modules 52 to optimise force applied by the interaction modules 52 to the surface. In some embodiments, the second array may include more sensors 69 to enhance resolution of the surface geometry estimation achievable by the controller 26.

The controller 26 may be configured to combine (or fuse) the distance data generated by the sensors 69 in the second array with the distance data generated by the sensors 69 of the first array, and may be combined with other sensor data, such as force data generated from force sensors associated with the brushes 60, 62, to further enhance accuracy and/or efficiency of control of the drive mechanisms 116 and/or interaction modules 52. This can enhance navigational precision about the structure 11, for example, to effect cleaning or other tasks performed with the interaction modules 52. It will be appreciated that data obtained from other sensors may be combined/fused with the distance data, by the controller 26, to optimise control of the drive mechanisms 116 and/or interaction modules 52. For example, this may involve obtaining and combining any of electrical current and/or rotational speed measurements from sensors associated with the thrusters 72, 74, electrical current and/or rotational speed measurements from sensors associated with the brushes 60, 62 (or motors driving the brushes 60, 62), and inertial measurement units (IMUs) associated with the interaction modules 52.

FIG. 11 illustrates positioning of a plurality of light emitters 90 spaced across the body 12 and from the imaging modules 18. Each light emitter 90 is operable to illuminate a field of view of at least one of the imaging modules 18. Generally, each light emitter 90 is spaced away from the imaging modules 18, and may be angled toward the field of view of one or more modules 18, to inhibit emitted light from illuminating immediately in front of the module, such as to avoid illuminating particles or bubbles prominently located in the field of view. The controller 26 is communicatively coupled with each of the light emitters 90 and configured to control operation of the light emitters 90, such as to activate/deactivate one or more of the light emitters 90, and adjust any of brightness, colour temperature and strobe frequency of illumination caused by each light emitter 90. Generally, each light emitter 90 includes one or more light emitting diodes (LEDs) however it will be appreciated that other illumination mechanisms are suitable.

In the illustrated embodiment 10, some of the light emitters 90 are configured as elongate light bars 92, and other light emitters are configured as spot lights 94. Operating the light bars 92 illuminates along a linear length. In practice, this emits a diffuse light or glow across a short range, typically employed for illuminating an object less than 100 mm away from the vehicle 10. In some circumstances, the light bars 92 may be operated to increase the emitted brightness to illuminate objects around 200 mm away from the vehicle 10, or greater than 200 mm for some applications. The diffused light emitted by the light bars 92 can usefully minimise reflections from particles, debris, and/or bubbles in the water and, consequently, enhance image quality captured by the imaging modules 18, which can enhance close range feature recognition and resulting navigational control by the controller 26, such as when moving about the structure 11. Operating the spot lights 94 illuminates a narrow beam across a longer range, typically employed for illuminating objects more than 50 mm away from the vehicle 10, which can enhance long range feature detection, such as when moving through open water or inspecting concave structures, recesses, or conduits, such as bow thrusters, or other complex geometries.

The light bars 92 are arranged to extend across the body 12 to emit light in a distributed, short range glow substantially across the fields of view of some of the imaging modules 18. In the illustrated embodiment, a pair of first light bars 921 are arranged to extend parallel to each other between the sides 22, 24 at the top 34 of the body 12 to illuminate about the top 34. The first light bars 921 are spaced apart towards the front 20 and rear 25 of the body 12 so that the third imaging module 18c is interposed between the light bars 921 such that operating the light bars 921 illuminates objects within the field of view of the third imaging module 18c and close to the vehicle 10. These light bars 921 may also be positioned between, and close to, the interaction modules 52 to enhance illuminating a structure being interacted with by the modules 52, such as the structure 11 being cleaned by the brushes 60, 62.

A pair of second light bars 922 are arranged to extend parallel to, and spaced apart from, each other along the sides 22, 24 of the body 12 to illuminate about the sides 22, 24. The second light bars 922 are mounted to the body 12, in this embodiment to pontoon members 96, to be operatively below one of the second imaging modules 18b such that operating the light bars 921 illuminates objects within the field of view of the second imaging modules 18b and close to the vehicle 10.

Operating the second light bars 922 emits light across the field of view of the module 18b, which can optimise image quality and, as a result, feature recognition by the controller 26.

The spot lights 94 are mounted to the body 12 to emit light in a focused, medium to long range beam substantially along the fields of view of some of the imaging modules 18. In the illustrated embodiment, an array of first spot lights 941 are mounted across the top 34 of the body 12 to illuminate about the top 34. Operating these spot lights 941 emits a plurality of beams of light directly away from the top 34 to illuminate objects within the field of view of the third imaging module 18c and distantly from the vehicle, for example, illuminating the structure 11 as the vehicle 10 is approaching to urge the brushes 60, 62 against the structure 11 for cleaning.

A pair of second spot lights 942 are mounted at the front 20 of the body 12, in this embodiment being carried by the pontoon members 96, to illuminate objects within the field of view of the first imaging module 18a and distantly from the vehicle, for example, illuminating the structure 11 as the vehicle 10 is travelling towards the structure 11 from a distant location.

The controller 26 is configured to operate any of the light emitters 92, including operating multiple light emitters 92 simultaneously, to illuminate around the vehicle 10. The controller 26 may be configured to operate the light emitters 92 based on one or more of: images captured by the plurality of imaging modules 18; distance data received from the range sensors 69; and estimated position and/or orientation of the vehicle 10 relative to the structure 11.

In some embodiments, the controller 26 is configured to dynamically adjust operation of the light emitters 92 (known as ‘active lighting’) as the vehicle 10 moves through the water based on any of a range of factors. The dynamic adjustment may be based on one or more of: the estimated or determined relative position and/or orientation of the vehicle 10 and the structure 11; the location of the vehicle 10 in the world; ambient light local to the vehicle 10; reflected light local to the vehicle 10, such as light emitted by the light emitters 92 and being reflected by the structure 11. Operating the light emitters 92 in this way can mitigate the potentially negative impact on image quality captured by the image modules 18 caused by the high dynamic range variability of light when illuminating the structure 11 in close proximity underwater.

For example, in some embodiments, the controller 26 assesses the distance data generated by the range sensors 69 at a defined frequency and, as a result, adjusts the brightness output of the light emitters 92 based on the measured proximity of the vehicle 10, or a portion of the vehicle 10, to the structure 11. This can usefully enhance colour and/or clarity of the images captured by the imaging modules 18, and/or inhibit creating ‘hotspots’ of light in the images, any of which can enhance feature detection in the images by the controller 26.

In other embodiments, the controller 26 assesses the images captured by the image modules 18 and, as a result, adjusts the brightness output of the light emitters 92 based on quantity and quality of features detected in the images, such as by assessing shadows and highlights present in the image.

In further embodiments, the controller 26 assesses the images captured by the image modules 18 in combination with estimated position data/location data, and/or operating condition data for the vehicle 10, compares current data to historical data and, as a result, adjusts the brightness output of the light emitters 92 based on previous visits to the same or similar position/location, and/or based on previous experiences of the same or similar situation.

In use, the vehicle 10 may be deployed from and retrieved to a base station, such as a pod or garage secured outside of the water, for example, on a boat or pontoon. The vehicle 10 may be mechanically tethered to the base station, such as for providing power to the vehicle 10. When the vehicle 10 is underwater, the imaging modules 18 are operated concurrently to image about the front 20 and the opposed sides 22, 24 of the body 12. The images are received and processed by the controller 26. Based on the processed images, and in some embodiments also based on additional sensed parameters, the controller 26 effects control of the drive mechanisms 16 to navigate the vehicle 10 relative to the structure 11, typically to avoid colliding the body 12, imaging modules 18 and drive mechanism(s) with the structure.

The illustrated embodiment of the vehicle 10 is operable to interact with the structure 11, such as to clean the structure 11. This involves the controller 26 effecting control of the drive mechanisms 16 to navigate the vehicle 10 to arrange the interaction modules 52, 68 relative to the structure 11, and operating the interaction modules 52, 68, in this embodiment causing cleaning of the structure 11.

Navigation in this scenario may include urging one or more of the rotating brushes 60, 62 into the structure 11, and/or pivoting the interaction module 52 into the extended configuration and urging the free end 58 against target portions of the structure 11, such as concave regions, or regions above the water line. When cleaning above the water line, typically only the second, outer brush 60 is rotated to inhibit water disturbance proximal to the vehicle 10 which can otherwise negatively affect image quality captured by the image modules 18, such as by creating air bubbles or turbulence, and hence interfere with the controller 26 maintaining navigational accuracy.

Advantageously, the plurality of imaging modules 18 imaging about at least two of the front 20, opposed sides 22, top 34, and bottom 35 of the body 12 can enhance the view horizon about the vehicle 10, such as defining a wide horizon ranging from one side 22 of the peripheral region 14 through to the other side 24. The arrangement of the imaging modules 18 means that features are visible within the fields of view 76, 78, 80 of the imaging modules 18 for prolonged periods of time, and/or may be imaged multiple times, and/or simultaneously by different imaging modules 18, to enhance perception of the environment surrounding the vehicle 10. The wide view horizon provided by the imaging modules 18 can enhance sensor time of obstacles that may come into the field of view 76, 78, 80 of the plurality of imaging modules 18, for example, portions of the structure submerged in water such as propellers of the vehicle, or marine life, which allows more time for the controller 26 to identify obstacles and actuate the drive mechanisms 16 to move the vehicle 10 away from the obstacles.

The plurality of imaging modules 18 are arranged to capture images in order to provide an accurate localisation of the vehicle 10, typically accurate to within 10 mm, in order to allow the vehicle 10 to navigate precisely relative to the structure.

Localisation is achieved by processing images defining the combined field of view of the concurrently operated plurality of imaging modules about two or more of the front 20, sides 22, 24, top 34, and bottom 35 of the body 12. Localisation may also involve incorporating data derived form additional on-board sensor inputs generated by any of the range of additional sensors which may be carried by the vehicle 10, as described above.

Where the vehicle 10 is required to navigate one side of the body 12, such as the top 36, close to the structure 11, such as to allow interaction with the structure 11, localisation may be enhanced by at least some of the plurality of imaging modules 18 facing transverse to the notional plane 40 defined by the body 12 to at least partly image about the top 34 of the body 12, and can be further enhanced by employing stereo cameras to resolve depth.

In the illustrated embodiment of the vehicle 10 configured to clean the structure, the vehicle 10 must navigate near to the structure for the interaction modules 52, 68 to be urged against the structure and operated to clean it. In this scenario, accurate localisation is advantageous to protect the vehicle 10 and the structure from being inadvertently damaged during the cleaning process, and to enhance effectiveness of cleaning. The arrangement of the interaction module 52 relative to the body 12 may be adjusted between the aligned configuration and the extended configuration, which can enhance protection of the vehicle 10 during a cleaning process by allowing the vehicle 10 to clean the structure from a safe distance, as well as allowing access to concave or hollow structures, such as inside pipes.

In embodiments where the imaging modules 18 are configured such that the fields of view 76, 78, 80 overlap, the view horizon can be continuous and is provided from one side 22 through to the other side 24, and includes the region at the front 20 of the body 12. This allows for increased obstacle awareness as the combined field of view that is stitched together may eliminate blind spots and/or further enhance sensing time, to optimise time available for the controller 26 to control the drive mechanisms 16 to navigate the vehicle 10 away from obstacles or about the structure.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. An underwater vehicle for navigating relative to a structure submerged in a body of water, the vehicle including:
a body having an operatively front, rear, opposed sides, top and bottom, and defining a peripheral region bounding the front, rear, and opposed sides;
one or more drive mechanisms carried by the body;
a plurality of imaging modules carried by the body to face away from the peripheral region, the plurality of imaging modules configured to operate concurrently to allow imaging at least partially about at least two of the front, opposed sides, top, and bottom of the body; and
a controller communicatively coupled with the plurality of imaging modules and the one or more drive mechanisms, the controller configured to control operation of the one or more drive mechanisms to navigate the vehicle about the structure based on images captured by the plurality of imaging modules.

2. The vehicle of claim 1, wherein the controller is configured to estimate at least one of a position and orientation of the vehicle relative to the structure based on the images captured by the plurality of imaging modules, and to control operation of the one or more drive mechanisms to navigate the vehicle about the structure based on at least one of the position and orientation of the vehicle.

3. The vehicle of claim 1 or 2, wherein the imaging modules are arranged by the body such that a first imaging module faces away from the front, and a pair of second imaging modules face away from each of the opposed sides.

4. The vehicle of claim 3, wherein the body defines a notional plane between the front and opposed sides, and at least some of the imaging modules are configured to face at a defined angle transverse to the plane to allow imaging about the top or bottom of the body.

5. The vehicle of claim 4, wherein each of the first and second imaging modules are arranged to face at the defined angle to allow concurrent imaging at least partially about the front, the opposed sides, and the top of the body.

6. The vehicle of claim 5, wherein the defined angle of the first imaging module is different to the defined angle of the second imaging modules.

7. The vehicle of any one of claims 4 to 6, wherein at least one of the imaging modules is arranged to face perpendicularly to the plane to image about the top of the body.

8. The vehicle of any one of claims 4 to 7, wherein the controller is configured to control operation of the one or more drive mechanisms to position the notional plane relative to the structure based on the images captured by the imaging modules arranged to face at the defined angle.

9. The vehicle of any one of claims 4 to 8, wherein the body carries an interaction module for interacting with the structure, and wherein at least one of the imaging modules is configured to face at the defined angle to allow imaging adjacent the interaction module, and wherein the controller is configured to control operation of the one or more drive mechanisms to position the interaction module relative to the structure based on the images captured by the at least some of the imaging modules, and operate the interaction module.

10. The vehicle of claim 9, wherein the interaction module defines an elongate structure defining a first end and an opposed second end, and is adjustably mounted to the body to allow positioning the second end to extend past the peripheral region to allow interacting with the structure.

11. The vehicle of claim 10, wherein the interaction module is mounted to the body to allow at least one of displacing the interaction module in a linear direction relative to the body, and rotating the interaction module about at least one axis.

12. The vehicle of any one of claim 9 to 11, where the interaction module is configured for cleaning the structure, and wherein the interaction module includes at least one rotatable brush at the second end.

13. The vehicle of any one of claims 9 to 12, wherein the body carries a pair of the interaction modules spaced apart from each other on the top of the body, and at least one of the imaging modules is arranged between the interaction modules to face perpendicularly to the plane to image about the top of the body.

14. The vehicle of any one of claims 4 to 13, wherein at least one of the imaging modules is mounted to the body by an adjustment mechanism operable to adjust the defined angle.

15. The vehicle of any one of the preceding claims, wherein each of the imaging modules is operable to define a field of view, and the imaging modules are arranged such that the field of view of at least two of the imaging modules overlap.

16. The vehicle of claim 15, wherein the at least two of the imaging modules are arranged such that the fields of view overlap to allow concurrent imaging at the at least two of the front, opposed sides, top, and bottom of the peripheral region.

17. The vehicle of any one of the preceding claims, wherein at least one of the imaging modules comprises a stereo pair of cameras.

18. The vehicle of claim 17, wherein the cameras of the stereo pair are arranged to be angled towards each other such that a field of view defined by each of the cameras overlaps with the other field of view.

19. The vehicle of any one of the preceding claims, wherein at least one of the imaging modules is covered by a domed lens.

20. The vehicle of any one of the preceding claims, further including a plurality of range sensors carried by the body to be spaced from each other, each range sensor operable to determine distance of an object relative to the body, and wherein the controller is communicatively coupled with the range sensors and configured to control operation of the one or more drive mechanisms based on distance data received from the range sensors.

21. The vehicle of claim 20, wherein the range sensors are arranged about the body to face away from the peripheral region and allow measuring distance relative to at least some of the front, opposed sides, and top of the body.

22. The vehicle of claim 1, wherein the body carries at least one interaction module for interacting with the structure and further including a plurality of range sensors carried by the body to be spaced from each other, each range sensor operable to determine distance of an object relative to the body, and wherein the controller is communicatively coupled with the range sensors and configured to control operation of the one or more drive mechanisms to position the interaction module relative to the structure based on at least one of the images captured by the imaging modules, and distance data received from the range sensors, and further configured to operate the at least one interaction module.

23. The vehicle of claim 22, including a pair of the interaction modules spaced from each other, each interaction module including at least one rotatable brush, and wherein the controller is configured to control operation of each interaction module to rotate the at least one brush based on at least one of the images captured by the imaging modules, and distance data received from the range sensors.

24. The vehicle of any one of the preceding claims, further including a plurality of light emitters carried by the body and spaced from the imaging modules, each light emitter operable to illuminate a field of view of at least one imaging module, and wherein the controller is communicatively coupled with the light emitters and configured to control operation of the light emitters.

25. The vehicle of claim 24, wherein at least some of the light emitters are configured as elongate light bars operable to illuminate along a linear length, wherein at least one light bar is arranged to extend between the opposed sides of the body to illuminate about the top of the body, and a pair of the light bars are spaced from each other to extend along, and illuminate about, the opposed sides of the body.

26. The vehicle of claim 24 or 25, wherein at least some of the light emitters are configured as spot lights operable to emit a narrow beam of light, wherein at least one spotlight is arranged to illuminate about the top of the body, and at least one spot light is arranged to illuminate about the front of the body.

27. The vehicle of any one of claims 24 to 26, wherein the controller is configured to control operation of the light emitters based on images captured by the plurality of imaging modules.

28. The vehicle of claim 1, further including a plurality of range sensors carried by the body to be spaced from each other, each range sensor operable to determine distance of an object relative to the body, and including a plurality of light emitters carried by the body and spaced from the imaging modules, each light emitter operable to illuminate a field of view of at least one imaging module, wherein the controller is communicatively coupled with the range sensors and the light emitters and further configured to control operation of the one or more drive mechanisms based on distance data received from the range sensors, and configured to control operation of the light emitters based on one or more of: images captured by the plurality of imaging modules;
distance data received from the range sensors; and estimated position and/or orientation of the vehicle relative to the structure.

29. The vehicle of claim 28, wherein the controller is configured to control operation of the light emitters to adjust one or more of brightness, colour temperature, and strobe frequency of illumination.

30. The vehicle of any one of the preceding claims, wherein the controller includes a processor sealably contained within the body.

31. The vehicle of any one of the preceding claims, wherein the controller is configured to effect autonomous navigation relative to the structure.

32. The vehicle of any one of the preceding claims, wherein the vehicle includes a base station mounted outside of the body of water, and a tether connecting the body to the base station.

33. The vehicle of claim 32, wherein the tether is configured to provide mechanical connection, and convey electrical power and data, between the body and the base station.

34. An underwater vehicle configured to clean a structure submerged in a body of water, the vehicle including:
a body defining a peripheral region; and
an elongate cleaning module operable to clean the structure, the cleaning module defining a first end and an opposed second end, the cleaning module being adjustably mounted to the body to allow at least one of displacing the cleaning module in a linear direction relative to the body, and rotating the cleaning module about at least one axis, to position the second end to extend past the peripheral region to access the structure.

35. The vehicle of claim 34, wherein the cleaning module defines a longitudinal axis between the ends and includes a first brush rotatably mounted about the longitudinal axis and arranged to extend axially from the second end.

36. The vehicle of claim 35, wherein the cleaning module further includes a second brush rotatably mounted about the longitudinal axis and spaced axially from the first brush, the first brush and the second brush being rotatable independently of each other.

37. The vehicle of any one of claims 34 to 36, wherein the body defines a notional plane extending across the peripheral region, and the cleaning module is carried by the body at one side of the plane to be at an operatively top or bottom of the body.

38. The vehicle of claim 37, including a further cleaning module carried by the body at the one side of the plane and spaced from the cleaning module, the further cleaning module defining an axis and having at least one brush rotatably mounted about the axis.

39. The vehicle of claim 38, wherein the further cleaning module has a pair of brushes rotatably mounted about the axis and configured to rotate independently of each other.
